(19) United States
(12) Patent Application Publication
(10) Pub. No.: US 2015/0055562 A1
(43) Pub. Date: Feb. 26, 2015

(54) NETWORK DEVICE INTERFACE FOR SUPPORTING A PLURALITY OF NETWORK INTERFACE CARDS

(71) Applicant: QUALCOMM INCORPORATED, SAN DIEGO, CA (US)

(72) Inventors: Vladimir Shulman, Haifa (IL); Moshe Noah, Yokneam (IL)

(73) Assignee: Wilocity Ltd., Caesarea (IL)

(21) Appl. No.: 13/971,090

(22) Filed: Aug. 20, 2013

(51) Int. Cl. H04W 40/12; H04W 72/08

(52) U.S. Cl. CPC H04W 40/12; H04W 72/085
USPC 370/329

(57) ABSTRACT

A network device interface configured for communication over a plurality of wireless networks is provided. The network device interface includes a first physical network interface card (NIC) configured to allow communication over a first type of wireless communication protocol; a second physical network interface card (NIC) configured to allow communication over a second type of wireless communication protocol, wherein the first and second communication protocols are different; at least a first miniport driver connected to the first physical NIC; at least a second miniport driver connected to the second physical NIC; a multiplexer (MUX) filter driver connected to the first miniport and the second miniport and configured to multiplex between the first miniport and the second miniport for at least switching sessions between the first physical NIC and the second physical NIC; and at least one network light weight filter (LWF) driver connected to the MUX filter driver.

### TECHNICAL FIELD

This invention generally relates to wireless networking, and more specifically the invention relates to fast switching between a plurality of wireless network interfaces to achieve optimal throughput.

### BACKGROUND

The 60 GHz band is a high bandwidth, unlicensed radio frequency band for wireless transmission of high volumes of data. The detailed communication protocol for the 60 GHz band (hereinafter Wi-Gig), has been defined by the Wi-Gig Alliance as IEEE 802.11ad. Multiple applications that require transmission of a large amount of data can be developed to allow wireless communication around the 60 GHz band. Examples for such applications include, but are not limited to, wireless high definition TV (HDTV), a wireless docking station, wireless Gigabit Ethernet, and many others.

Drawbacks of the 60 GHz band are its extremely limited range and susceptibility to signal loss caused by obstacles in the line of sight between transmitter and receiver, including a person crossing the signal path. Accordingly, Wi-Gig transmission cannot be relied upon as an exclusive wireless communication.

A more robust wireless connection is Wi-Fi as specified, for example, in the IEEE standard 802.11n/g to allow devices to exchange data wirelessly in a computer network, including high-speed Internet connections. Wi-Fi operates over unlicensed frequency bands of 2.4 GHz and 5 GHz, has a much longer range than Wi-Gig but, in comparison, suffers from considerably lower bandwidth, which limits its use in high transmission applications such as streaming high definition content.

In order to provide the highest possible bandwidth without sacrificing reliability, an advanced wireless device should support both Wi-Gig and Wi-Fi and it should be able to auto-negotiate between the different bands according to whichever provides the best transmission.

Any wireless device to support both the Wi-Fi and Wi-Gig transmission includes antennas to receive and transmit millimeter wave signals in the Wi-Fi bands of 2.4 GHz and 5 GHz as well as in the Wi-Gig band of 60 GHz. In addition, such a device should include a wireless network interface card (NIC) that can enable communication in these frequency bands.

However, implementation of a unified tri-band radio-based wireless NIC is highly complex. Alternatively, a wireless device could be designed to implement two separate NICs operating in the Wi-Fi and the Wi-Gig bands. In this configuration, each wireless NIC can independently manage the communication in its respective band. In addition, the wireless NICs can communicate connection status and session information among each other. For example, in a tri-band configuration, the Wi-Fi NIC can provide a fallback mechanism to a more robust transmission when the Wi-Gig transmission becomes unstable.

In order to support a configuration using separate NICs, a multiplexing (MUX) driver is integrated in a network device interface specification (NDIS) driver stack. As discussed in the related art, the NDIS is an application programming interface (API) for network interface cards (NICs) used in Microsoft® Windows®-based operating systems. The NDIS interface forms the logical link control (LLC) and acts as the interface between the media access control (MAC) layer and the network layer (layer 3, TCP/IP). The NDIS interface entails an upper-level protocol driver, e.g., the TCP/IP protocol driver (on the top of the stack architecture), the intermediate and miniport drivers in the middle of the stack architecture, and a NIC at the bottom of the communications stack.

FIG. 1 illustrates a conventional arrangement of an NDIS stack 100 designed to support two NICs 101-A and 101-B using a MUX filter driver 160. This kind of conventional arrangement is supported by Microsoft®. Each of the NICs 101-A and 101-B is respectively connected to a miniport driver 150-A and 150-B, wherein the miniport drivers 150-A and 150-B directly manage their respective NICs and provide an interface to higher-level filter drivers. In the NDIS stack 100, each miniport driver 150-A and 150-B is respectively connected to an instance of a native Wi-Fi (NWIFI) filter driver 130-A and 130-B.

The MUX filter driver 160 manages the connection between a TCP/IP protocol driver 110 and the NWIFI filter drivers 130-A and 130-B. Typically, the MUX filter driver 160 can act as an intermediate driver interfaces between the TCP/IP protocol driver 110 and the NWIFI filter drivers 130-A and 130-B. The MUX driver 160 decides how to aggregate or multiplex the capabilities of the NICs 101-A and 101-B. The TCP/IP protocol driver 110 implements an application-specific interface to provide services to users of the network. Typically, the protocol driver 110 provides a protocol interface to pass packets to and receive incoming packets from the next-lower driver.

The configuration of the NDIS stack 100 entails insertion of an intermediate 1-to-n MUX filter driver 160 directly below the TCP/IP protocol driver 110, and then multiplexing over the two (or more) separate NWIFI filter drivers 130-A and 130-B.

This configuration maintains compatibility within the driver stack with future service packs of existing operating systems (OS) and/or with new OS. However, the two NICs 101-A and 101-B appear as separate NICs to the OS. As a result, it is difficult to transfer sessions from one frequency band to the other. Furthermore, such configuration does not provide the abstraction of a single network interface necessary to provide bandwidth increase and optimal user experience.

Other challenges with designing such stacks include complicated internal bindings and data paths and a highly problematic management of connections. More importantly, there is no guarantee that even a service pack for the operating system will maintain functionality of this particular configuration.

As discussed above, none of the existing NDIS interface configurations provides an optimal solution for integrating two or more separate wireless NICs operating in tandem and, more specifically, as a tri-band interface combining the Wi-Fi and Wi-Gig bands. Therefore, it would be advantageous to provide a driver implementation which combines the at least two wireless NICs into a single abstraction that appears to the host as a combined tri-band radio. It would be further advantageous to provide a solution that would allow seamless fast session transfer without the added complexity of the tri-band design.

### SUMMARY

Certain embodiments disclosed herein include a network device interface configured for communication over a plurality of wireless networks is provided. The network device interface includes a first physical network interface card (NIC) configured to allow communication over a first type of wireless communication protocol; a second physical network interface card (NIC) configured to allow communication over a second type of wireless communication protocol, wherein the first and second communication protocols are different; at least a first miniport driver connected to the first physical NIC; at least a second miniport driver connected to the second physical NIC; a multiplexer (MUX) filter driver connected to the first miniport and the second miniport and configured to multiplex between the first miniport and the second miniport for at least switching sessions between the first physical NIC and the second physical NIC; and at least one network light weight filter (LWF) driver connected to the MUX filter driver.

Certain embodiments disclosed herein also include a tri-band network device interface. The device interface comprises a Wi-Fi physical network interface card (NIC) configured to allow communication between over a first frequency band and a second frequency band; a Wi-Gig physical network interface card (NIC) configured to allow communication over a third frequency band; at least a Wi-Fi miniport driver connected to the Wi-Fi physical NIC; at least a Wi-Gig miniport driver connected to the Wi-Gig physical NIC; a multiplexer (MUX) filter driver connected to the Wi-Fi miniport and the Wi-Gig miniport and configured to multiplex between the Wi-Gig miniport and the Wi-Fi miniport to at least switch sessions between the Wi-Gig NIC and the Wi-Fi NIC; virtual Wi-Fi (VWIFI) filter driver connected to the MUX filter driver; and a native Wi-Fi (NWIFI) filter driver connected to the MUX filter driver.

Certain embodiments disclosed herein also include a method for enabling communication through at least first and second wireless network interface cards (NICs) included in a multi-band network device interface that interfaces between an operating system and wireless networks. The method comprises receiving a request packet issued by the operating system; duplicating the received request packet; forwarding the duplicate received request packets to at least a first miniport connected to the first wireless NIC and a second miniport connected to the second wireless NIC; wait to receive responses from both the first miniport and the second miniport; combining the received responses into a single response, thereby masking the response of the second miniport; and returning to the operating system the combined response, thereby the host is not aware of the any connection flow on the second miniport.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 illustrates a conventional arrangement of an NDIS stack with a MUX driver filter driver according to one configuration.

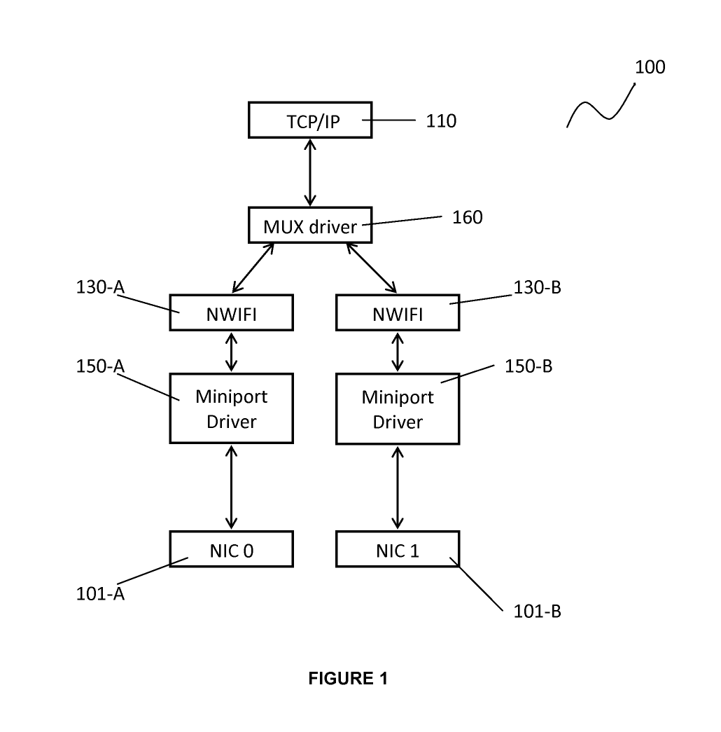

FIG. 2 is a diagram of a network device interface configured according to one embodiment.

FIG. 3 is a diagram of a network device interface configured to support Wi-Gig and Wi-Fi NICs according to one embodiment.

FIG. 4 is a flowchart illustrating a process for handling requests and responses by the MUX filter driver according to one embodiment.

FIG. 5 is a diagram illustrating an example for handling OID_SCAN_REQUEST by the MUX filter driver.

FIG. 6 illustrating a link selection process performed by the MUX filer driver according to on embodiment.

FIG. 7 is a diagram illustrating an Information Element format constructed according to one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments disclosed herein include a network device interface, an apparatus, and methods for supporting a plurality of NICs. The disclosed embodiments allow for maintaining both connections and switching sessions among the plurality of NICs for optimal connectivity and throughput.

In a preferred embodiment, the plurality of NICs operate in different frequency bands including, but not limited to Wi-Gig and Wi-Fi bands as defined above. In such embodiments, the use of the Wi-Gig or Wi-Fi in any specific session is determined by a pre-defined trigger event based on the highest attainable signal quality and rate or else on a threshold for signal quality and/or transmission speed below which Wi-Fi is selected over Wi-Gig, including a hysteresis feature to avoid unnecessary switching and the associated switching latencies. Specifically, for enabling fault tolerance among the NICs, the session can fall back onto a Wi-Fi link as a robust base transmission when the Wi-Gig link drops out and/or the Wi-Fi link provides faster and more robust connectivity. In one embodiment, selection of the optional link is performed by a MUX filter driver as discussed in greater detail below.

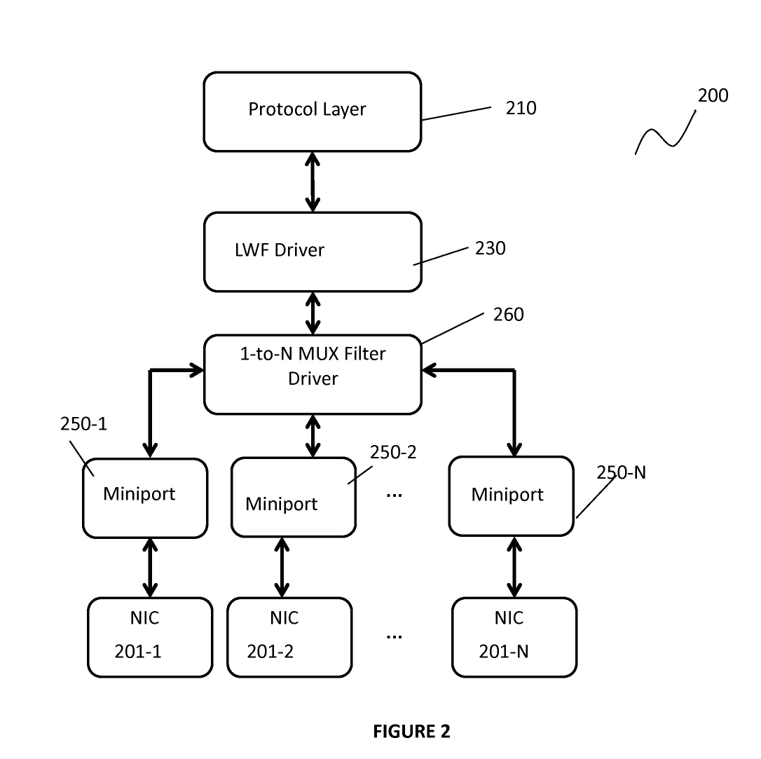

FIG. 2 shows an exemplary and non-limiting diagram of a network device interface 200 configured according to one embodiment. The disclosed interface 200 presents itself as a conventional network driver, such as an NDIS to the operating system (e.g., Microsoft Windows-type OS).

The interface 200 includes a number of N miniport drivers 250-1 through 250-N, respectively connected to a number of N NICs 201-1 through 201-N. The NICs 201 may support wired and wireless networking standards. In a preferred embodiment, discussed in detail below, the NICs 201 may include a Wi-Fi and Wi-Gig NICs. Each miniport driver 250 directly manages its respective NIC 201 and provides an interface to higher-level filter drivers.

The interface 200 also includes a stack of a 1-to-N MUX filter driver 260, at least one network Light Weight Filter (LWF) driver 230, and a protocol layer driver 210 arranged as shown in FIG. 2. The at least one LWF driver 230 is a filter driver defined in the NDIS specification 6.0 that offers a combination of NDIS intermediate drivers and a miniport driver. The LWF driver monitors and filters network packets in Windows-type OS. Currently, there are several LWF driver modules available by Microsoft® including, but not limited to, NWIFI, VWIFI, and the like, which may be added to the interface 200 based on the required network connectivity.

The protocol layer driver 210 is a TCP/IP protocol driver that implements an application-specific interface to provide services to users of the network and provides a protocol interface to pass packets to and receive incoming packets from the LWF driver 230.

According to certain embodiments disclosed herein, the 1-to-N MUX filter driver 260 is designed as a LWF filter and implements various functions for maintaining and detecting at least two connections and switching sessions among the NICs 201. The MUX driver 260 also provides an abstraction layer to the N number of NICs 201, thereby enabling the host (not shown) to treat the number of N NICs as a single network interface card. The host is a processor or the computing device in which the network device interface 200 is connected and operable. In one embodiment, the miniport drivers 250 and the LWF driver 230 interface with the disclosed MUX driver 260 through a proprietary application programming interface (API). This enables connectivity to any standardized and proprietary NICs 201 and miniport drivers 250.

According to one embodiment, the MUX driver 260 is configured to multiplex between the NICs 201-1 through 201-N. Each session can use one or more of the NICs 201, according to the MUX driver 260. In one embodiment, a default NIC 201 for providing the connectivity is set. Typically, a NIC providing a reliable link, e.g., a signal quality above a predefined value, an error rate below a predefined threshold, and the like is determined as the default NIC (e.g., NIC 201-1). The connectivity switches to the default NIC when the link quality of supported by another NIC (e.g., NIC 201-2) is downgraded or the link is unavailable. The switching can also be performed from the default link NIC 201-1 to, e.g., NIC 201-2 when the link of the latter satisfies a predefined level of performance. As will be described below, the MUX filter driver 260 handles the switching between NICs in a seamless way that does not allow continuous network connectivity. The decision to switch between NICs is made by means of a link selection process implemented by the device interface 200.

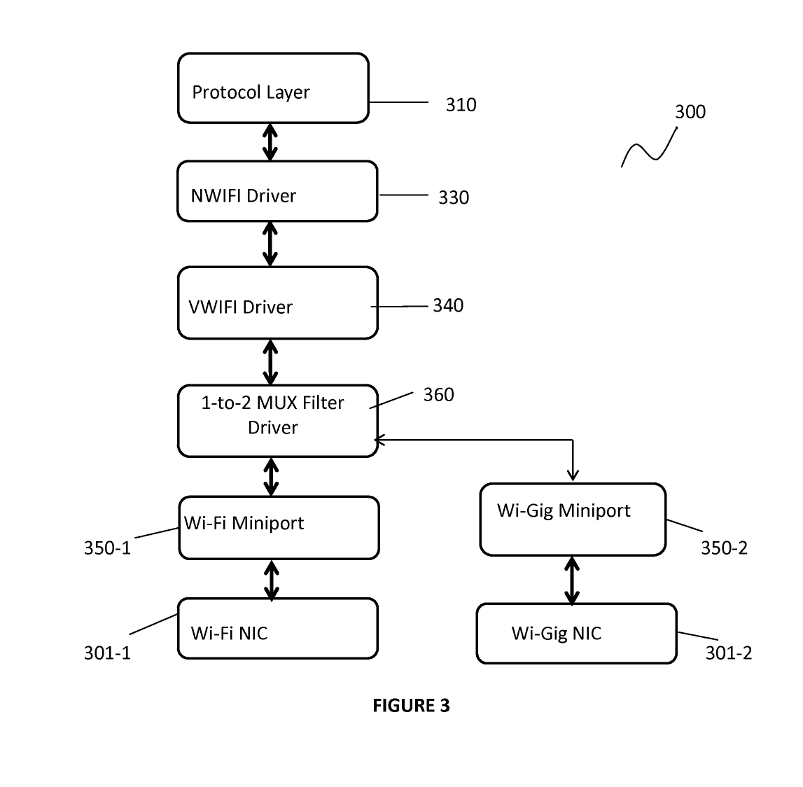

FIG. 3 shows a non-limiting and exemplary diagram of a network device interface 300 configured to support both Wi-Fi and Wi-Gig wireless connectivity according to one embodiment. The disclosed interface 300 simulates a conventional network driver, such as an NDIS to the operating system (e.g., Microsoft Windows-type OS).

As noted above, the Wi-Gig as defined in the IEEE 802.11ad specifies the communication protocol for the 60 GHz frequency band. The Wi-Fi as specified, for example, in the IEEE standard 802.11n/g allows devices to exchange data wirelessly over a computer network, including high-speed Internet connections. The Wi-Fi operates over unlicensed frequency bands of 2.4 GHz and 5 GHz. Thus, the disclosed network device interface 300 can support a tri-band radio-based wireless NIC.

The interface 300 includes two miniport drivers 350-1 and 350-2 respectively attached to a Wi-Fi NIC 301-1 and a Wi-Gig NIC 301-2. The Wi-Fi NIC 301-1 provides connectivity over a Wi-Fi wireless link in the frequency bands of 2.4 GHz and 5 GHz, while the Wi-Gig NIC 301-2 provides a wireless link over the 60 GHz frequency band. The miniport drivers 350-1 and 350-2 are respectively Wi-Fi and Wi-Gig miniport drivers that manage the Wi-Fi NIC 301-1 and the Wi-Gig NIC 301-2. The operation of such miniport drivers are known to those of ordinary skill.

The interface 300 also includes a stack of a 1-to-2 MUX filter driver 360 (or simply referred to as MUX driver 360) connected to the miniport drivers 350-1 and 350-2 at the one end, and, on the other end, to a virtual Wi-Fi light weight filter driver (hereinafter VWIFI driver) 340 which is connected to a native Wi-Fi light weight filter driver (hereinafter NWIFI driver) 330, and a protocol layer 310 arranged as shown in FIG. 3. The VWIFI and NWIFI drivers 340 and 330 perform native Wi-Fi operations such as object identifier (OID) scanning and point to point (P2P) binding. In one embodiment, the drivers 330 and 340 are standard NWIFI and VWIFI Microsoft® drivers. The protocol layer driver 310 is a TCP/IP protocol driver as discussed above with respect to FIG. 2.

Certain disclosed embodiments are realized through by the 1-to-2 MUX filter driver 360 which, like the MUX 260, is designed as a light weight filter driver. Specifically, the MUX filter driver 360 is configured to multiplex between Wi-Fi and Wi-Gig NICs 301-1 and 301-2, while both NICs appear to the user as a single NIC. An active session can be established through the Wi-Fi NIC 301-1, Wi-Gig 301-2, or both based on a decision made by a MUX filter driver 360. In one embodiment, the default connectivity is set to be a Wi-Fi link through the Wi-Fi NIC 301-1.

According to one embodiment, the MUX filter driver 360 switches the connectivity to the Wi-Fi NIC 301-1 when the link quality or transfer rate of the Wi-Gig NIC 301-2 is downgraded or the link is unavailable. The switching can also be performed from the default link Wi-Fi NIC 301-1 to the Wi-Gig NIC 301-2 when the link of the latter exceeds a predefined level of a link quality. As the Wi-Gig link offers 10 times higher bandwidth than a Wi-Fi link, it is preferable to switch to the Wi-Gig NIC 301-2, whenever the Wi-Gig link is reliable. The predefined level of performance to determine a reliable Wi-Gig link may include, for example, an error rate below a predefined value, a signal strength threshold, a transmission rate, and so on.

In one embodiment, the MUX filter driver 360 performs fast session transfer (FST) to dynamically switch the session between the Wi-Fi and Wi-Gig during an active session connection. In another embodiment, the MUX filter driver 360 supports static transfer modes in which all traffic is always directed to the Wi-Fi NIC 301-1 or the Wi-Gig link 301-2. An exemplary and non-limiting embodiment for the operation of the FST process is described below.

In one embodiment, the Wi-Fi miniport driver 350-1 (and as such the NIC 301-1) are enabled and connected to the MUX driver 360 in order to allow the operation of the Wi-Gig miniport driver 350-2 and its respective NIC 301-2. That is, when the Wi-Fi miniport driver 350-1 is disabled, the Wi-Gig miniport driver 350-2 is disabled as well.

In one embodiment, the MUX filter driver 360 configures the Wi-Fi and Wi-Gig miniport drivers 350-1, 350-2 in such way that only the Wi-Fi miniport driver 350-1 appears to be bound to the NWIFI driver 330, while the binding for the Wi-Gig miniport 350-2 is completely transparent to the NWIFI driver 330. To this end, APIs provided by the Wi-Gig protocol for NDIS drivers or modules (such as VWIFI/NWIFI interfaces) are disabled, and all proprietary (non-standardized NDIS interfaces) are declared as available interfaces. The MUX filter driver 360 is configured to declare available interfaces of the Wi-Fi miniport driver 350-1 as well as the proprietary interfaces of the Wi-Gig driver 350-2.

In one embodiment, the MUX driver 360 is preconfigured with a list of miniport drivers that can be bound thereto. Upon initialization, the MUX driver 360 checks that the miniport drivers connected thereto are in the preconfigured list, and rejects the drivers that are not listed.

According to certain embodiments, the MUX filter driver 360 can operate in two modes of operations: “pass through” or “MUX”. In the pass through mode, all communication from VWIFI and NWIFI filter drivers 340 and 330 are passed to either the Wi-Fi miniport 350-1 or the Wi-Gig miniport 350-2 based on a default configuration. The MUX driver 360 is further configured to detect all available links and make a decision regarding in which mode to operate. If both links for Wi-Fi and Wi-Gig are available and the MUX mode of operation is set, then the Wi-Gig link is used by the MUX driver 360. That is, packets from “upper” drivers are passed through to the Wi-Gig miniport 350-2. In addition, in the MUX mode, the MUX filter driver 360 can switch to the Wi-Fi link when the Wi-Gig link is disconnected; or otherwise degraded. The decision as to which link to switch is performed by a link selection process implemented by the MUX filter driver 360 and discussed in greater detail above.

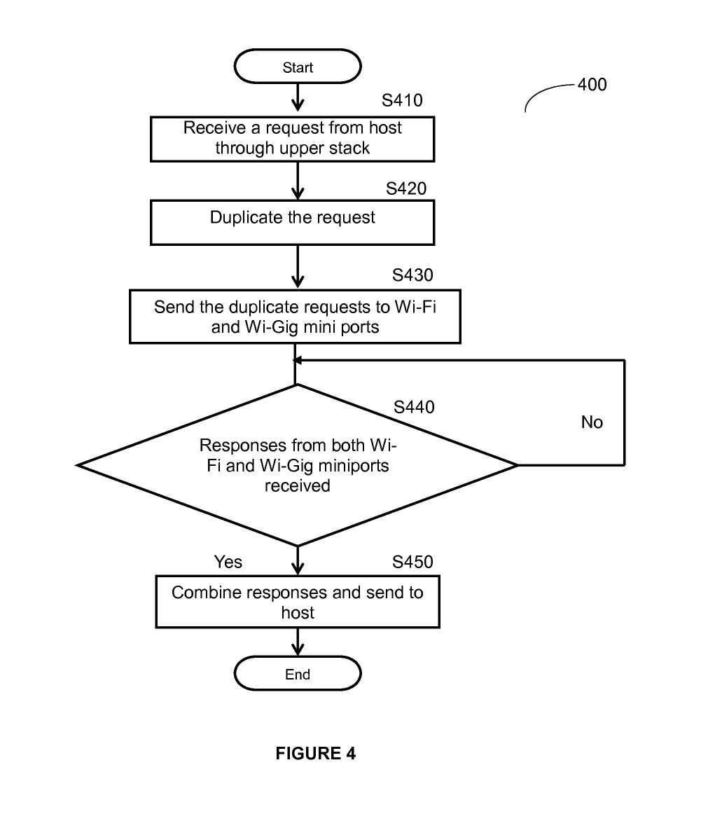

FIG. 4 shows an exemplary flowchart 400 illustrating a process for handling requests and responses by the MUX driver filter 360 according to one embodiment. At S410, a request sent by the host (not shown) through the upper stack drivers (e.g., drivers 310, 330, and 330) is received at MUX filter driver. The request may be an OID_SCAN_REQUEST or an OID_DOT11_CONNECT_REQUEST. The request does not include any data. It should be noted that the request can process OIDs sent from the host, such as OID_DOT11_CURRENT_PHY_ID; ID_DOT11_OPERATIONAL_RATE_SET; OID_DOT11_DESIRED_SSID_LIST; OID_DOT11_DESIRED_BSS_TYPE; OID_DOT11_ENABLED_AUTHENTICATION_ALGORITHM; OID_DOT11_ENABLED_UNICAST_CIPHER_ALGORITHM; OID_DOT11_ENABLED_MULTICAST_CIPHER_ALGORITHM; OID_DOT11_EXCLUDE_UNENCRYPTED; and OID_DOT11_PRIVACY_EXEMPTION_LIST

Subsequently, at S420 the received request is duplicated. Then, at S430 the duplicated requests are forwarded to the Wi-Fi and Wi-Gig miniports (e.g., miniports 350-1 and 350-2).

Thereafter, at S440, the MUX filter driver is configured to wait for the responses from the miniports. When a response from the Wi-Fi miniport is received, it is kept pending until a response from the Wi-Gig miniport has been received as well. At S450, upon reception of both responses from both miniport drivers, such responses are combined and sent to the host through the upper stack driver. The Wi-Gig responses (OIDs) are not forwarded to the host, which is not aware of any connection flow on the Wi-Gig miniport 350-2.

After a successful connection, the host 10 may also issue several post-connection OIDs: OID_GEN_CURRENT_PACKET_FILTER; OID_DOT11_CIPHER_KEY_MAPPING_KEY; and OID_DOT11_CIPHER_DEFAULT_KEY OID_802_3_MULTICAST_LIST

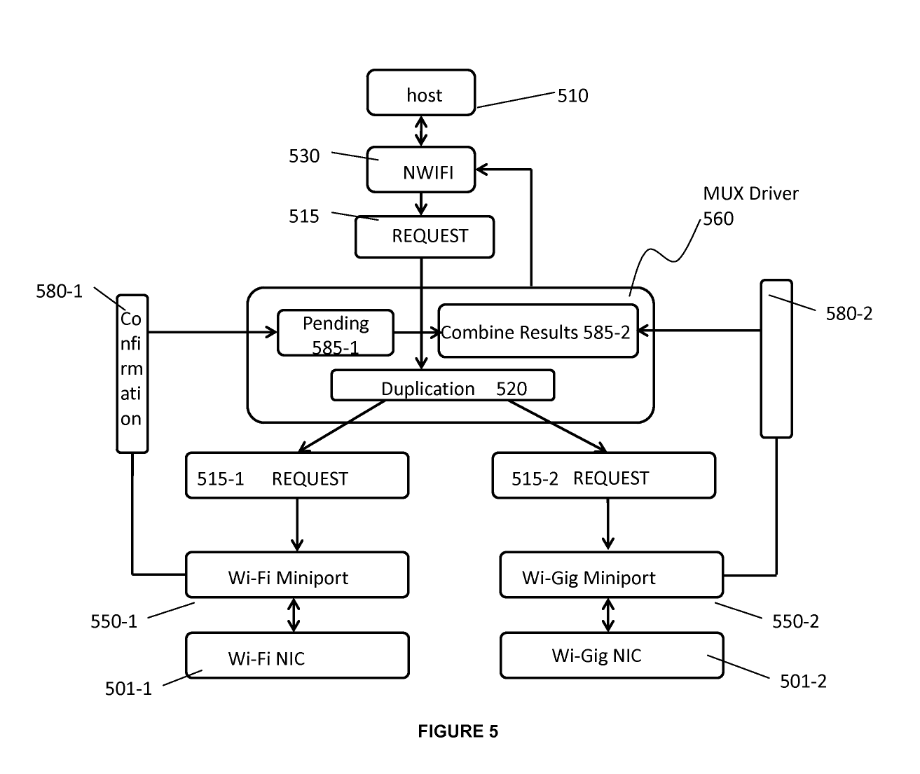

The operation of the MUX driver is illustrated in FIG. 5 using the OID_SCAN_REQUEST as non-limiting example. The host 510 issues a scan request 515, which is passed through the upper level drivers as for example from the NWIFI filter driver 530 to the MUX filter driver 560. The driver 560, in turn uses scan duplication 520 and then propagates the duplicated scan requests 515-1, 2 to the Wi-Fi miniport 550-1 and Wi-Gig miniport 550-2 connected to Wi-Fi NIC 501-1 and 501-2, respectively.

The Wi-Fi miniport 550-1 returns the confirmation 580-1 to the MUX driver 560 where it is kept pending 585-1. The Wi-Gig miniport 550-2 also returns the confirmation 580-2 to the MUX driver 560 where it is combined with the pending results 585-1 from the Wi-Fi miniport 550-1 to a unified scan result 6585-2, which is then returned through the NWIFI driver 530 to the host 510. The presence of the Wi-Gig connection is masked by the MUX driver 560 and completely transparent to the NDIS, and the two NICs 501-1 and 501-2 appear as a single NIC to the system. The same mode of operation also applies to other requests, for example enumeration of basic set services and connect requests.

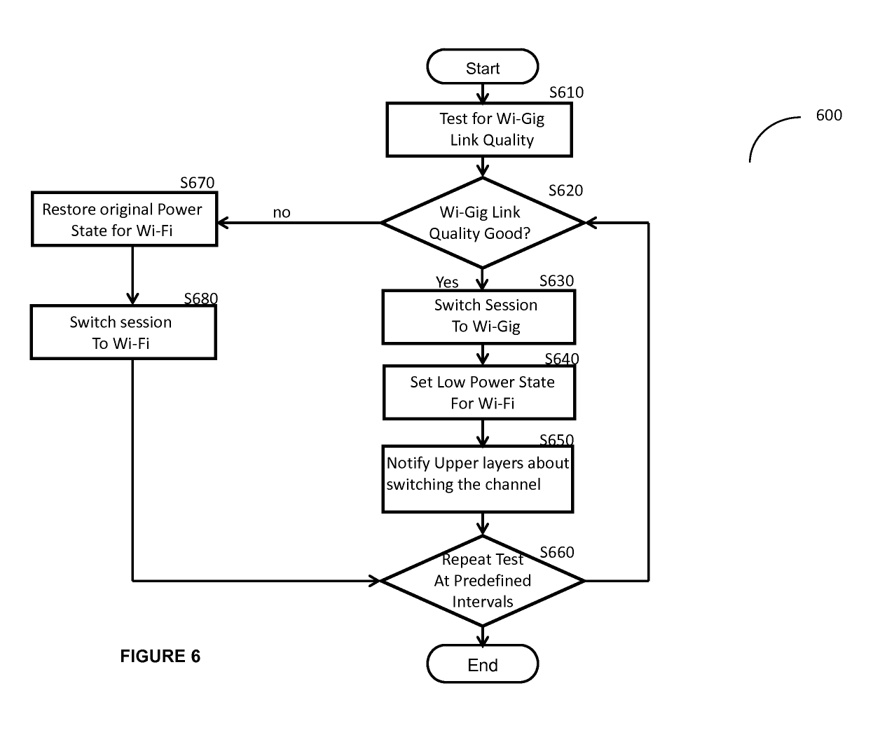

FIG. 6 shows an exemplary and non-limiting flowchart 600 illustrating the link selection process performed by the disclosed MUX filter driver according to one embodiment. At S610, the quality of the Wi-Gig link is periodically tested. The test link quality parameters include, for example, one or more of the following measures: signal strength, a packet error rate (PER), bandwidth, a transmission rate, and so on. In one embodiment, S610 is performed by a link quality monitor that is configured to monitor the Wi-Gig link comprising the Wi-Gig miniport driver and the Wi-Gig NIC. The link monitor may be a proprietary API and may be incorporated into the MUX driver.

At S620, it is checked if the Wi-Gig link quality is sufficient S620, and if so, execution continues with S630; and subsequently, execution proceeds to S640. The check performed at S620 is considered sufficient if the one or more measured quality parameters meet a predefined threshold.

Upon determination that Wi-Gig link quality is sufficient, at S630, the MUX filter driver switches to the Wi-Gig link. The switching includes transferring an active session associated with the Wi-Fi miniport and NIC to the Wi-Gig miniport and NIC. It should be noted that S630 is performed only if the session is through the Wi-Fi NIC prior to the execution of S630.

At S640, a low power state is initiated for the Wi-Fi link. At S650, the upper stack driver (e.g., drivers 410, 430, and 430) are informed about the changes to the link. The Wi-Gig link quality test is repeated S660 at periodic intervals that can be user defined or depend on the history of the Wi-Gig test results.

If, at S620, the Wi-Gig link quality is determined to be insufficient, then at S670, the original power state for the Wi-Fi link is restored. At S680 the active link is switched from the Wi-Gig link to the Wi-Fi link. This includes transferring the session from one link to another. Also in this case, the testing of the quality and speed of the Wi-Gig link is repeated S660 as discussed above until the session is terminated or the Wi-Fi link is disconnected. It should be noted that S670 is performed only if the session is through the Wi-Gig NIC prior to the execution of S670.

It should be appreciated that the method disclosed above provides a process for selecting the optimal link for the wireless communication at any given time. In a preferred embodiment this is realized through the device network interface discussed with reference to FIG. 3. It should be further appreciated that having the MUX filter driver 460 connected in the configuration shown with respect to FIG. 3 enables to transparently transfer sessions between the miniports 350-1 and 350-2. The actual session transfer can be performed by means of a fast session transfer (FST) algorithm discussed in the related art. An example for such an algorithm can be found in the 802.11ad specification.

According to one embodiment, for connecting to a wireless network, the disclosed MUX filter driver catches the information elements (IEs), for example, OID_DOT11_ADDITIONAL_IE transmitted on the Wi-Fi link. The management information base specifies the values of the additional IEs. If a Wi-Gig link exists, the MUX filter driver is configured to add an appropriate proprietary IE (X60_MULTY_LINK_IE) which will be injected to all Wi-Fi link beacons. If such OID was not detected, the MUX filter driver is configured to create the OID and send it to the Wi-Fi link.

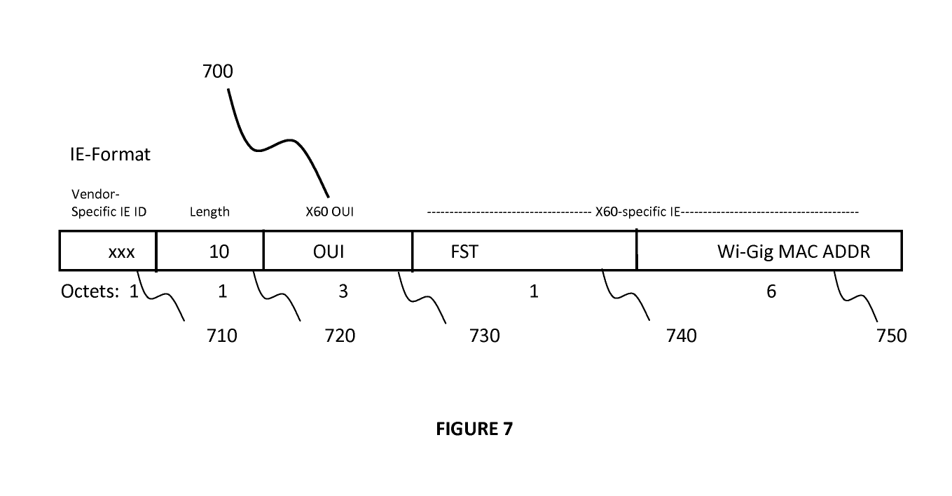

FIG. 7 shows an exemplary and non-limiting diagram illustrating an IE format 700 constructed according to one embodiment. The first octet contains a vendor-specific ID 710, followed by a length field 720, an organizationally unique identifier 730, an FST field 740, and a MAC address for the Wi-Gig NIC 750. The fields 740 and 750 are specific for the proprietary IE (X60_MULTY_LINK_IE). When a successful Wi-Fi link connection has been established, the MUX filter driver is configured to issue a scan on the Wi-Gig link. The MUX filter driver is further configured to read the Wi-Gig MAC address of a device to which it is wirelessly connected. This address is designated in the field 750. The MUX filter driver periodically issues a scan of the Wi-Gig link, until a network with a MAC address matching the MAC address designated in beacons transmitted over the Wi-Fi link is detected. The MAC address may be found in the OID_DOT11_ADDITIONAL_IE.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A network device interface configured for communication over a plurality of wireless networks, comprising:
a first physical network interface card (NIC) configured to allow communication over a first type of wireless communication protocol;
a second physical network interface card (NIC) configured to allow communication over a second type of wireless communication protocol, wherein the first and second communication protocols are different;
at least a first miniport driver connected to the first physical NIC;
at least a second miniport driver connected to the second physical NIC;
a multiplexer (MUX) filter driver connected to the first miniport and the second miniport and configured to multiplex between the first miniport and the second miniport for at least switching sessions between the first physical NIC and the second physical NIC; and
at least one network light weight filter (LWF) driver connected to the MUX filter driver.

2. The network device interface of claim 1, further comprises:
a protocol layer driver connected to the at least one LWF driver.

3. The network device interface of claim 1, wherein the MUX filter driver is further configured to switch sessions between the first physical NIC and the second physical NIC based on a quality of a link supported by each of the first physical NIC and the second physical NIC.

4. The network device interface of claim 3, wherein the quality of link is determined based on at least one of: signal strength, a packet error rate (PER), bandwidth, a transmission rate.

5. The network device interface of claim 3, wherein the link supported by the first physical NIC is determined to be a default link, and wherein the switching to the default link happens when the link supported by the second physical NIC is determined to be unreliable or slower than that of the first link.

6. The network device interface of claim 5, wherein the MUX filter driver operates in a pass-through mode and a MUX mode, wherein in the pass-through mode all packets from the protocol layer driver are passed to either the first or the second miniport, wherein in the MUX mode, the packets from the protocol layer driver are passed to any one of the first miniport and the second miniport associated with the link determined to be reliable.

7. The network device interface of claim 1, wherein the MUX filter driver is further configured to:
receive a request packet issued by a host, wherein the request packet is received at the MUX filter driver through the protocol layer driver and the LWF driver;
duplicate the receive request packet;
forward the duplicate received request packets to the first miniport and the second miniport;
wait to receive responses from both the first miniport and the second miniport;
combine the responses received from the first and the second miniport into a single response, wherein the response from the second miniport is masked; and
return to the host the combined response as a response received from the first miniport, thereby the host is not aware of any connection flow on the second miniport.

8. The network device interface of claim 7, wherein the first miniport is a Wi-Fi miniport compliant with the IEEE standard 802.11n/g and the second miniport is a Wi-Gig miniport compliant with the IEEE standard 802.11ad.

9. The network device interface of claim 7, wherein the at least one LWF driver comprises a native Wi-Fi filter driver and a virtual Wi-Fi light weight filter driver.

10. The network device interface of claim 1, wherein the MUX filter driver is a light weight filter driver.

11. The network device interface of claim 2, wherein the protocol layer driver, the at least one LWF driver, and the MUX filter driver are stacked such that the protocol layer driver is at top, the MUX filter driver is at bottom, and the at least one LWF driver is at middle of the stack.

12. A tri-band network device interface, comprising:
a Wi-Fi physical network interface card (NIC) configured to allow communication between over a first frequency band and a second frequency band;
a Wi-Gig physical network interface card (NIC) configured to allow communication over a third frequency band;
at least a Wi-Fi miniport driver connected to the Wi-Fi physical NIC;
at least a Wi-Gig miniport driver connected to the Wi-Gig physical NIC;
a multiplexer (MUX) filter driver connected to the Wi-Fi miniport and the Wi-Gig miniport and configured to multiplex between the Wi-Gig miniport and the Wi-Fi miniport to at least switch sessions between the Wi-Gig NIC and the Wi-Fi NIC;
a virtual Wi-Fi (VWIFI) filter driver connected to the MUX filter driver; and
a native Wi-Fi (NWIFI) filter driver connected to the MUX filter driver.

13. The tri-band network device interface of claim 12, further comprises:
a protocol layer driver connected to the at least one NWIFI filter driver.

14. The tri-band network device interface of claim 12, wherein the MUX filter driver is further configured to switch sessions between the Wi-Fi physical NIC and the Wi-Gig physical NIC based on a quality of a link supported by each of the Wi-Fi physical NIC and the Wi-Gig physical NIC.

15. The tri-band network device interface of claim 14, wherein the quality of link is determined based on at least one of: signal strength, a packet error rate (PER), bandwidth, a transmission rate.

16. The tri-band network device interface of claim 15, wherein the link supported by the Wi-Fi physical NIC is determined to be a default link, wherein the switching to the default link happens when the link supported by the Wi-Gig physical NIC is determined to be unreliable or slower than the link supported by the Wi-Fi physical NIC.

17. The tri-band network device interface of claim 15, wherein the MUX filter driver is further configured to perform a link selection process to determine the reliable link to switch to, wherein the link selection process includes:
periodically testing the quality of the link supported by the Wi-Gig physical NIC;
checking if the tested link quality satisfies a predefined quality threshold;
when the tested link quality satisfies the predefined quality threshold, selecting the link supported by the Wi-Gig physical link, and setting the Wi-Fi physical NIC to a low power state; and
when the tested link quality does not satisfy the predefined quality threshold, restoring the power state of the Wi-Fi physical NIC and selecting the link supported by the Wi-Fi physical link.

18. The tri-band network device interface of claim 17, wherein the MUX filter driver is further configured to:
transfer an active session associated with the Wi-Fi miniport to the Wi-Gig miniport when switching to the link supported by the Wi-Gig;
transfer an active session associated with the Wi-Gig miniport to the Wi-Fi miniport when switching to the link supported by the Wi-Gig; and
inform the NWIFI filter driver and VWIFI filter driver of the link switching.

19. The tri-band network device interface of claim 12, wherein the MUX filter driver is further configured to:
receive a request packet issued by a host, wherein the request packet is received at the MUX filter driver through the protocol layer driver, the NWIFI filter driver and the VWIFI filter driver;
duplicate the receive request packet;
forward the duplicate received request packets to the Wi-Fi miniport and the Wi-Gig miniport;
wait to receive responses from both the Wi-Fi miniport and the Wi-Gig miniport;
combine both responses into a single response, wherein the Wi-Gig miniport response is masked; and
return to the host the combined response to the host, thereby the host is not aware of the any connection flow on the Wi-Gig miniport.

20. The tri-band network device interface of claim 12, wherein the Wi-Fi miniport is compliant with the IEEE standard 802.11n/g and the Wi-Gig miniport is compliant with the IEEE standard 802.11ad.

21. The tri-band network device interface of claim 12, wherein the first and second frequency bands are 2.4 GHz and 5 GHz respectively, and the third frequency band is 60 GHz.

22. The tri-band network device interface of claim 12, wherein the MUX filter driver is a light weight filter.

23. The tri-band network device interface of claim 12, wherein the tri-band network device interface presents itself to an operating system of a host as a network device interface specification (NDIS)-compliant interface.

24. A method for enabling communication through at least first and second wireless network interface cards (NICs) included in a multi-band network device interface that interfaces between an operating system and wireless networks, comprising:
receiving a request packet issued by the operating system;
duplicating the received request packet;
forwarding the duplicate received request packets to at least a first miniport connected to the first wireless NIC and a second miniport connected to the second wireless NIC;
wait to receive responses from both the first miniport and the second miniport;
combining the received responses into a single response, thereby masking the response of the second miniport; and
returning to the operating system the combined response, thereby the host is not aware of the any connection flow on the second miniport.

25. The method of claim 24, wherein the first miniport is a Wi-Fi miniport compliant with the IEEE 802.11n/g standard and the second miniport is a Wi-Gig miniport compliant with the IEEE 802.11ad standard.

26. The method of claim 25, further comprises performing a link selection process to select a reliable link from a Wi-Fi link and a Wi-Gig link, wherein the link selection process comprising:
periodically testing a quality of the Wi-Gig link;
checking if the tested link quality satisfies a predefined quality threshold;
when the tested link quality satisfies the predefined quality threshold, selecting the Wi-Gig link, and setting the first wireless NIC supporting the Wi-Fi link to a low power state; and
when the tested link quality does not satisfy the predefined quality threshold, restoring the power state for the Wi-Fi first wireless NIC and selecting the Wi-Fi physical link.

27. The method of claim 26, further comprises:
transferring an active session associated with the Wi-Fi miniport to the Wi-Gig miniport when switching to the Wi-Gig link;
transferring an active session associated with the Wi-Gig miniport to the Wi-Fi miniport when switching to the Wi-Fi link; and
informing drivers included in the network device interface of the link switching.
